(19) United States
(12) Patent Application Publication
(10) Pub. No.: US 2017/0219018 A1
(43) Pub. Date: Aug. 3, 2017

(54) TOLERANCE RING FOR TORQUE TRANSMISSION DEVICE

(71) Applicant: TOGO SEISAKUSYO CORPORATION, Aichi-gun, Aichi (JP)

(72) Inventor: Hirofumi KURACHI, Aichi (JP)

(21) Appl. No.: 15/034,846

(22) PCT Filed: Feb. 18, 2015
(86) PCT No.: PCT/JP2015/054403

§ 371 Date: May 5, 2016

(30) Foreign Application Priority Data
Feb. 20, 2014 (JP) 2014-030321

(51) Int. Cl. F16D 7/02

(52) U.S. Cl. CPC F16D 7/021

(57) ABSTRACT

A tolerance ring for a torque transmission device is arranged in an annular space between an inner shaft member and an outer shaft member. The tolerance ring has a ring-shaped portion and a plurality of protrusions. The ring-shaped portion has a cylindrical shape and is brought into contact with one of the shaft members. The plurality of protrusions undergo elastic deformation and are arranged in a peripheral direction. The ring-shaped portion has seat portions formed between the protrusions that are adjacent to each other in the peripheral direction. The plurality of protrusions include selected protrusions that have the same shape and that are situated at the same axial position and unselected protrusions other than the selected protrusions. The selected protrusions and the unselected protrusions differ from each other in axial position of center point in a length direction.

### CROSS-REFERENCE TO RELATED APPLICATIONS

The present application is a National Phase entry of, and claims priority to, PCT Application No. PCT/JP2015/054403, filed Feb. 18, 2015, which claims priority to Japanese Patent Application No. 2014-030321, filed Feb. 20, 2014, both of which are incorporated herein by reference in their entireties for all purposes.

### STATEMENT REGARDING FEDERALLY SPONSORED RESEARCH OR DEVELOPMENT

Not applicable

### BACKGROUND

The present invention relates to a tolerance ring for a torque transmission device.

JP2002-308119A discloses a tolerance ring for a torque transmission device. FIGS. 14 and 15 of the present application correspond to FIGS. 3 and 5(a) of the above-mentioned publication. As shown in FIG. 14, a torque transmission device 110 has an inner shaft member 112, an outer shaft member 114, and a tolerance ring 120. The inner shaft member 112 and the outer shaft member 114 are concentric with each other and are arranged so as to overlap each other in the radial direction. The tolerance ring 120 is installed in an annular space between the two shaft members 112 and 114.

When the torque between the two shaft members 112 and 114 is smaller than a predetermined value, the tolerance ring 120 does not slip on the two shaft members 112 and 114. Thus, the tolerance ring 120 transmits torque between the two shaft members 112 and 114. When the torque is not smaller than the predetermined value, the tolerance ring 120 slips on one of the two shaft members 112 and 114. Thus, the tolerance ring 120 interrupts the torque transmission between the two shaft members 112 and 114. Accordingly, the tolerance ring 120 functions as a torque limiter.

As shown in FIG. 15, the tolerance ring 120 has a ring-shaped portion 124 that has a cylindrical tubular shape, and a large number of protrusions 126 formed on the ring-shaped portion 124. As shown in FIGS. 17 and 18, the protrusions 126 are swollen outwards in the radial direction from the ring-shaped portion 124. As shown in FIGS. 15 and 16, a large number of protrusions 126 have the same shape, and are arranged on the ring-shaped portion 124 so as to be side by side in the peripheral direction. The large number of protrusions 126 are arranged on the same axial position with respect to the ring-shaped portion 124 (See FIG. 16). The ring-shaped portion 124 has seat portions 124b situated between neighboring protrusions 126. The seat portions 124b may contact a peripheral surface of the inner shaft member 112 (See FIG. 18). The protrusions 126 are elastically deformed between the two shaft members 112 and 114. The protrusions 126 have ridge portions 128 that contact the outer shaft member 114 under a predetermined pressure by utilizing an elastic force thereof. Thus, when the torque between the two shaft members 112 and 114 is not smaller than a predetermined value, the ring-shaped portion 124 slips on the inner shaft member 112.

The larger the reaction force due to the deformation of the protrusions 126, the higher the contact pressure between the seat portions 124b and the inner shaft member 112. The smaller the contact area between the seat portions 124b and the inner shaft member 112, the higher the contact pressure mentioned-above. When the seat portions 124b slip on the inner shaft member 112, the higher the above-mentioned contact pressure, the higher the aggressiveness of the seat portions 124b with respect to the inner shaft member 112. Both end portions of each protrusion 126 are less subject to deformation than the central portion, and have little relief margin for the deformation. Thus, the contact pressure between each seat portion 124b and the inner shaft member 112 is high at both ends in the axial direction (See lines L in FIG. 16), and low at the central portion.

The large number of protrusions 126 have the same shape and are arranged on the same axial position. Thus, the end portions of the seat portions 124b, i.e., the portions where the contact pressure is high, are aligned in the rotational direction (See lines L in FIG. 16). As a result of repeated slipping of the tolerance ring 120 on the inner shaft member 112, the seat portions 124b may wear out the inner shaft member 112, resulting in a reduction in the slip torque.

As a measure for reducing the contact pressure between the inner shaft member 112 and the seat portions 124b, it might be possible to make the radius of curvature of the connection portions 127 between the seat portions 124b and the protrusions 126 (See FIG. 18) as large as possible. In this configuration, the contact area between the inner shaft member 112 and the seat portions 124b would be increased due to the deformation of the connection portions 127 accompanying the deformation of the protrusions 126. Thus, the contact pressure between the inner shaft member 112 and the seat portions 124b would decrease. It should be noted, however, that the radius of curvature of the connection portions 127 is roughly determined by design conditions (requisite torque and an outer diameter of the inner shaft member 112). Thus, range for capable of changing in design of the connection portions 127 with regard to the radius of curvature is not large.

As described above, the slip torque can be reduced when the tolerance ring slips repeatedly with respect to one shaft member of the torque transmission device. There has been a need for a tolerance ring that is capable of suppressing the reduction in torque.

### BRIEF SUMMARY

According to one feature of the present invention, a tolerance ring is arranged in an annular space between an inner shaft member and an outer shaft member which are concentric with each other and which overlap each other in a radial direction. When torque between the two shaft members is smaller than a predetermined value, the tolerance ring transmits the torque between the two shaft members, and when the torque between the two shaft members is not smaller than the predetermined value, the tolerance ring slips on at least one of the two shaft members to interrupt the torque transmission between the two shaft members. The tolerance ring has a cylindrical ring-shaped portion configured to be brought into contact with one of the two shaft members, and a plurality of protrusions which undergo elastic deformation between the two shaft members and which are arranged in a peripheral direction. The ring-shaped portion has seat portions formed between the protrusions that are adjacent to each other in the peripheral direction. The plurality of protrusions include selected protrusions that have the same shape and that are situated at the same axial position and unselected protrusions other than the selected protrusions. The selected protrusions and the unselected protrusions differ from each other at least in one of total length, ridge length, end portion shape, and axial position of center point in a length direction.

The seat portions come into contact with one of the shaft member. The seat portion position of high contact pressure is determined by the total length, ridge length, end portion shape, and the axial position of the center point in the length direction. Thus, the high pressure portions of the selected protrusions and the high pressure portions of the unselected protrusions are dispersed in the axial direction, and are not aligned in the peripheral direction. Thus, it is possible to suppress the phenomenon of a reduction in slip torque in which the reduction is caused through repeated slipping of the seat portions on one of the shaft member.

### BRIEF DESCRIPTION OF THE DRAWINGS

FIG. 1 is a cross-sectional view of a torque transmission device;

FIG. 2 is a perspective view of a tolerance ring;

FIG. 3 is a development view of the tolerance ring;

FIG. 4 is an enlarged view of a part of the FIG. 3;

FIG. 5 is a cross-sectional view taken along line V-V in FIG. 4;

FIG. 6 is a cross-sectional view taken along line VI-VI in FIG. 4;

FIG. 7 is a development view of a tolerance ring according to another embodiment;

FIG. 8 is a development view of a tolerance ring according to another embodiment;

FIG. 9 is a development view of a tolerance ring according to another embodiment;

FIG. 10 is a development view of a tolerance ring according to another embodiment;

FIG. 11 is a development view of a tolerance ring according to another embodiment;

FIG. 12 is a development view of a tolerance ring according to another embodiment;

FIG. 13 is an enlarged view of a part of the FIG. 12;

FIG. 14 is a cross-sectional view of a torque transmission device according to a conventional example;

FIG. 15 is a perspective view of the tolerance ring of FIG. 14;

FIG. 16 is a development view of a part of the tolerance ring of FIG. 15;

FIG. 17 is a cross-sectional view taken along line XVII-XVII in FIG. 16; and

FIG. 18 is a cross-sectional view taken along line XVIII-XVIII in FIG. 16.

### DETAILED DESCRIPTION

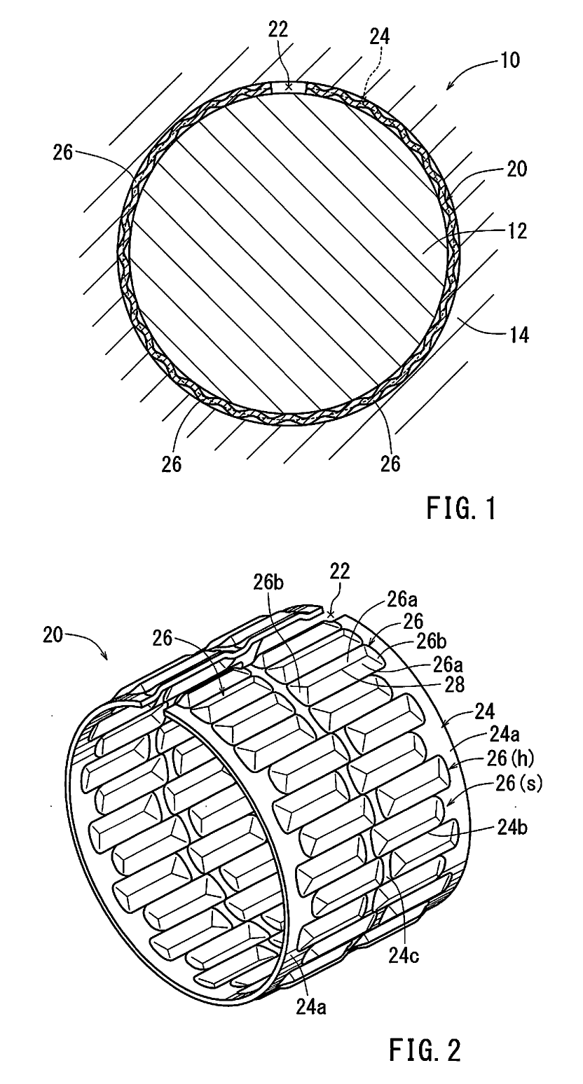

An embodiment of the present invention will be described with reference to FIGS. 1 to 6. As shown in FIG. 1, a torque transmission device 10 has an inner shaft member 12, an outer shaft member 14, and a tolerance ring 20. The inner shaft member 12 has an outer peripheral surface of a cross-sectional circular shape, and the inner shaft member 12 has, for example, a columnar or cylindrical shape. The outer shaft member 14 has an inner peripheral surface of a cross-sectional circular shape, and the outer shaft member 14 has, for example, a cylindrical shape. The inner shaft member 12 and the outer shaft member 14 are concentric with each other, and overlap each other in the radial direction.

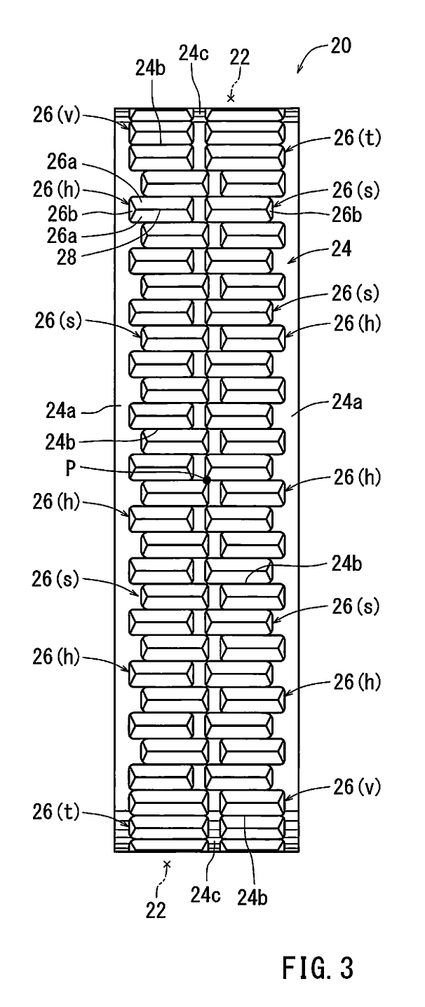

As shown in FIG. 1, the tolerance ring 20 is placed in an annular space between the inner shaft member 12 and the outer shaft member 14. The tolerance ring 20 is formed through bending a flat intermediate product shown in FIG. 3 into a cylindrical shape as shown in FIG. 2. The intermediate product of the tolerance ring 20 is formed through press working of a metal spring plate member. Right-left direction in FIG. 3 corresponds to an axial direction, and a vertical direction in FIG. 3 corresponds to a peripheral direction.

As shown in FIG. 2, the tolerance ring 20 includes a ring-shaped portion 24 and a plurality of protrusions 26. The ring-shaped portion 24 has a cylindrical shape with a mating part 22, where it is cut in the peripheral direction. The plurality of protrusions 26 are arranged side by side in the peripheral direction on the ring-shaped portion 24. The plurality of protrusions 26 are arranged side by side at predetermined intervals over the entire peripheral length of the ring-shaped portion 24. The plurality of protrusions 26 are continuously adjacent with each other, for example, in the peripheral direction, involving substantially no gaps therebetween.

As shown in FIG. 1, the ring-shaped portion 24 is inserted between the inner shaft member 12 and the outer shaft member 14 while undergoing elastic deformation in a diverging direction. The ring-shaped portion 24 is reduced in diameter due to elastic restoration, and is brought into close contact with the outer peripheral surface of the inner shaft member 12. The protrusions 26 are located between the two shaft members 12 and 14, and undergo elastic deformation or, in addition thereto, plastic deformation. As a result, the apex portions of the protrusions 26 are brought into close contact with, or engaged in, the inner peripheral surface of the outer shaft member 14. Due to the elastic force of the protrusions 26, the tolerance ring 20 is brought into close contact with the two shaft members 12 and 14.

When the torque between the two shaft members 12 and 14 is smaller than a predetermined value, the tolerance ring 20 does not slip on the two shaft members 12 and 14. As a result, the tolerance ring 20 transmits torque between the two shaft members 12 and 14. When the torque between the two shaft members 12 and 14 is not smaller than the predetermined value, the tolerance ring 20 slips on one or both of the two shaft members 12 and 14. As a result, the tolerance ring 20 interrupts the torque transmission between the two shaft members 12 and 14, and allows relative rotation of the two shaft members 12 and 14. Thus, the tolerance ring 20 functions as a torque limiter.

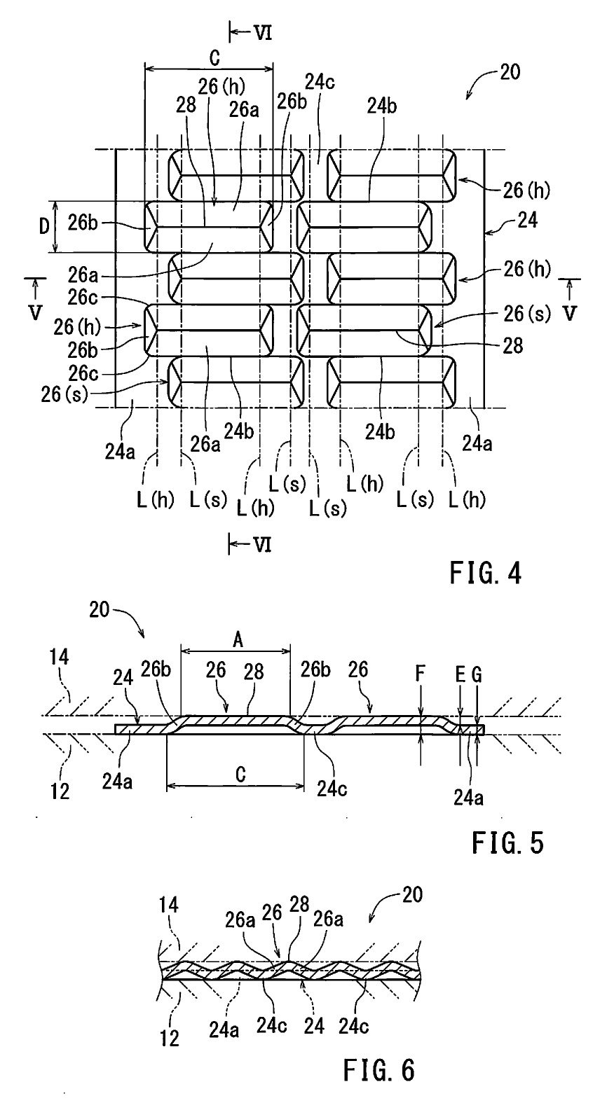

As shown in FIG. 2, the protrusions 26 have a chevron shape, for example, a hipped roof shape, and protrude radially outwards from the ring-shaped portion 24. As shown in FIGS. 4 to 6, the plurality of protrusions 26 are arranged continuously in the peripheral direction. Each protrusion 26 extends in the axial direction, and has side walls 26a and end walls 26b. The side walls 26a have substantially a rectangular shape, and constitute slopes of the chevron. The end walls 26b have substantially a triangular shape, and close both ends in the axial direction of both side walls 26a. A ridge 28 is formed between the two side walls 26a. As shown in FIG. 5, the ridge 28 has a ridge length A. The tolerance ring 20 has two rows of protrusions 26 arranged side by side in the axial direction. The protrusions 26 situated at both ends in the peripheral direction of each row (the upper end and the lower end in FIG. 3) have a half-cut shape in the peripheral direction.

As shown in FIG. 4, each protrusion 26 has four corners 26c. The each corner 26c has an arcuate shape exhibiting a predetermined radius of curvature between each end wall 26b and each side wall 26a. Each protrusion 26 has a total length C in the axial direction, and a total width D in the peripheral direction. As shown in FIG. 5, in a free state, the protrusion 26 exhibits a free height E. The tolerance ring 20 has a product height F. The ring-shaped portion 24 has a thickness G. The product height F corresponds to the sum total of the free height E and the thickness G. The product height F is larger than the radial dimension of the annular space between the two shaft members 12 and 14 (half of the value obtained by subtracting the outer diameter of the inner shaft member 12 from the inner diameter of the outer shaft member 14).

As shown in FIG. 4, the ring-shaped portion 24 has side edge portions 24a, seat portions 24b, and a partition portion 24c. Both side edge portions 24a extend along both ends in the axial direction. The seat portions 24b are formed between the adjacent protrusions 26. The partition portion 24c is formed between the two rows of protrusions 26. One end portion in the axial direction of each seat portion 24b is connected to the side edge portion 24a, and the other end portion thereof is connected to the partition portion 24c. The side edge portions 24a, the partition portion 24c, and the seat portions 24b are formed in the same circumferential plane.

As shown in FIG. 3, the plurality of protrusions 26 are situated in point symmetry with respect to the central point P of the ring-shaped portion 24. In the following, the left-hand side row of protrusions 26 in FIG. 3 will be described, and a description of the right-hand side row thereof will be left out. The left-hand side row of protrusions 26 has first protrusions 26(s) as selected protrusions, and has second protrusions 26(h), third protrusions 26(t), and fourth protrusions 26(v) as unselected protrusions.

As shown in FIG. 3, the first protrusions 26(s) and the second protrusions 26(h) are situated in the central region excluding the region in the vicinity of the mating part 22 of the ring-shaped portion 24. The first protrusions 26(s) and the second protrusions 26(h) are situated alternately in the peripheral direction. The first protrusions 26(s) and the second protrusions 26(h) are situated so as to be deviated by a predetermined amount in the axial direction. The first protrusions 26(s) are situated so as to be deviated from the second protrusions 26(h) on one side (to the right in FIG. 3) by a predetermined amount. The first protrusions 26(s) and the second protrusions 26(h) have the center points that situate on the deferent positions each other in the length direction. The plurality of first protrusions 26(s) have the same shape and situated on the same axial position. The plurality of second protrusions 26(h) have the same shape and situate on the same axial position. The number of first protrusions 26(s) and the number of second protrusions 26(h) are not restricted to those of the embodiment shown in FIG. 3.

As shown in FIG. 4, both corners 26c of the first protrusions 26(s) exhibit a radius of curvature larger than that of both corners 26c of the second protrusions 26(h). Thus, the first protrusions 26(s) and the second protrusions 26(h) have end portions with different shapes. The total length C and the ridge length A of the first protrusions 26(s) (See FIG. 5) are slightly larger than the total length C and the ridge length A of the second protrusions 26(h). The first protrusions 26(s) and the second protrusions 26(h) have the same total width D (See FIG. 4).

As shown in FIG. 3, two and a half third protrusions 26(t) are arranged side by side in one region in the vicinity of the mating part 22 of the ring-shaped portion 24 (left lower region and right upper region in FIG. 3). Two and a half fourth protrusions 26(v) are arranged side by side in the other region in the vicinity of the mating part 22 of the ring-shaped portion 24 (left upper region and right lower region in FIG. 3). The third protrusions 26(t) are axially longer than the first protrusions 26(s) and the second protrusions 26(h). One ends (left ends) of the third protrusions 26(t) are situated in correspondence with one ends of the second protrusions 26(h), and are arranged side by side in the peripheral direction. The other ends (right ends) of the third protrusions 26(t) are situated in correspondence with one ends of the first protrusions 26(s), and are arranged side by side in the peripheral direction. The fourth protrusions (v) have the same axial length as the second protrusions 26(h), and are situated so as to be axially in correspondence with the second protrusions 26(h).

As shown in FIG. 3, the partition portion 24c between the two rows of protrusions 26 is formed in a fixed manner. For example, the axial distance between the third protrusion 26(t) and the fourth protrusion 26(v) in the lower region in FIG. 3 is substantially the same as the axial distance between the first protrusion 26(s) and the second protrusion 26(h) in the vicinity of the central point P. The third protrusion 26(t) and the fourth protrusion 26(v) exhibit a total width D diminished stepwise as they situate toward the mating part 22. The middle one of the two and a half third protrusions 26(t) has corners 26c of a larger radius of curvature than the corners 26c of the second protrusions 26(h). The number of third protrusions 26(t) and the number of fourth protrusions 26(v) are not restricted to those of the embodiment of FIG. 3.

As shown in FIGS. 4 and 5, the portions of the tolerance ring 20 brought into contact with the inner shaft member 12 at high pressure are portions of the seat portions 24b corresponding to the ends of the ridges 28. Thus, the high-pressure portions of the seat portions 24b of the first protrusions 26(s) are situated on the line L(s). The high-pressure portions of the seat portions 24b of the second protrusions 26(h) are situated on the line L(h). As described above, the first protrusions 26(s) and the second protrusions 26(h) differ from each other in total length C, ridge length A, end portion shape, and the axial position of the center point in the length direction. Thus, the line L(s) and the line L(h) differ from each other in the axial position, and the high-pressure portions are situated so as to be dispersed in the axial direction. As a result, it is possible to prevent accumulative concentration of high-pressure portions at a specific position. Further, due to the dispersion of the high-pressure portions, the pressure of each high-pressure portion with respect to the inner shaft member 12 is diminished. Thus, due to the synergetic effect of the prevention of concentration of high-pressure portions and the reduction in pressure, the aggressiveness with respect to the inner shaft member 12 is mitigated. Thus, it is possible to suppress a reduction in slip torque due to the repeated slipping of the tolerance ring 20 on the inner shaft member 12.

In the conventional example, the reduction amount of the slip torque (the reaction force of the protrusions) is large according to the number of times that the tolerance ring slips. Thus, in view of the reduction amount, it is necessary to set the initial slip torque high so that it may not be below the prescribed slip torque. As a result, it is rather difficult to mount the tolerance ring between the two shaft members. In contrast, in the tolerance ring 20 of the present embodiment, the reduction amount of the slip torque is small. Thus, it is possible to set the initial slip torque low. As a result, the requisite force for mounting the tolerance ring 20 between the two shaft members 12 and 14 is reduced.

As described above, the first protrusions 26(s) and the second protrusions 26(h) differ from each other in the axial position of the center point in the length direction and the end portion shape. Thus, when mounting the tolerance ring 20 to the outer shaft member 14, there is a deviation in press-in timing between the first protrusions 26(s) and the second protrusions 26(h) with respect to the outer shaft member 14. As a result, the requisite force for mounting the tolerance ring 20 is diminished.

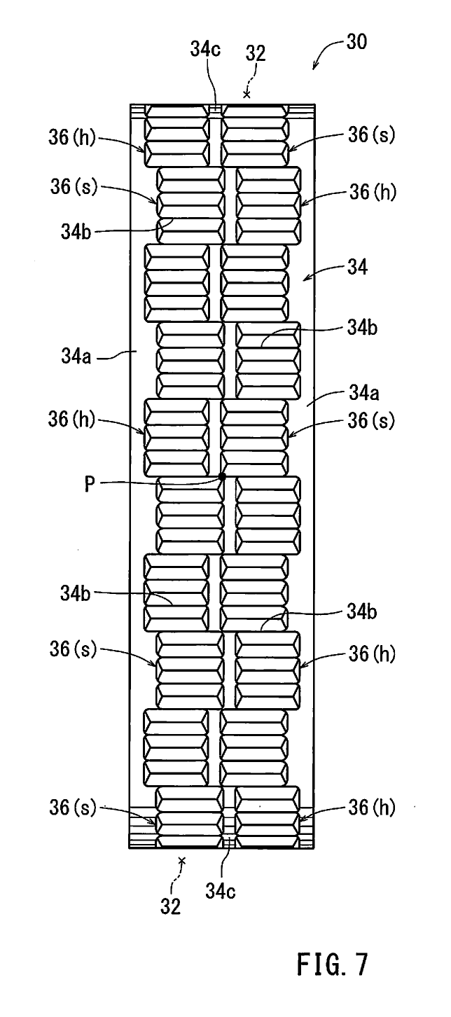

Instead of the tolerance ring 20 shown in FIG. 3, the torque transmission device 10 may have a tolerance ring as shown in FIGS. 7 to 13. In the following, each tolerance ring shown in FIGS. 7 to 13 will be described centering on the differences from the tolerance ring 20; and a redundant description will be left out.

A tolerance ring 30 shown in FIG. 7 includes a cylindrical ring-shaped portion 34 having a mating part 32, and two rows of protrusions 36. The ring-shaped portion 34 has side edge portions 34a, seat portions 34b, and a partition portion 34c. The protrusions 36 include fifth protrusions 36(s) as selected protrusions, and sixth protrusions 36(h) as unselected protrusions. The fifth protrusions 36(s) have the same shape as the first protrusions 26(s) of FIG. 3, and are arranged at the same axial position as the first protrusions 26(s). The sixth protrusions 36(h) have the same shape as the second protrusions 26(h) of FIG. 3, and are arranged at the same axial position as the second protrusions 26(h).

As shown in FIG. 7, a plurality of (e.g., three) fifth protrusions 36(s) are continuously arranged side by side in the peripheral direction, forming selected protrusion groups. A plurality of (e.g., three) sixth protrusions 36(h) are continuously arranged side by side in the peripheral direction, forming unselected protrusion groups. The selected protrusion groups and the unselected protrusion groups are arranged alternately side by side in the peripheral direction. For example, two and a half fifth protrusions 36(s) are arranged in one region in the vicinity of the mating part 32 of the left row (left lower region) and the other region in the vicinity of the mating part 32 of the right row (right upper region). For example, two and a half sixth protrusions 36(h) are arranged in the other region in the vicinity of the mating part 32 of the left row (left upper region) and one region in the vicinity of the mating part 32 of the right row (right lower region).

The fifth protrusions 36(s) and the sixth protrusions 36(h) shown in FIG. 7 differ from each other in total length C, ridge length A, end portion shape, and the axial position of the center point in the length direction. Thus, the high-pressure portions of the seat portions 34b with respect to the inner shaft member 12 are dispersed in the axial direction, and are not aligned in the peripheral direction.

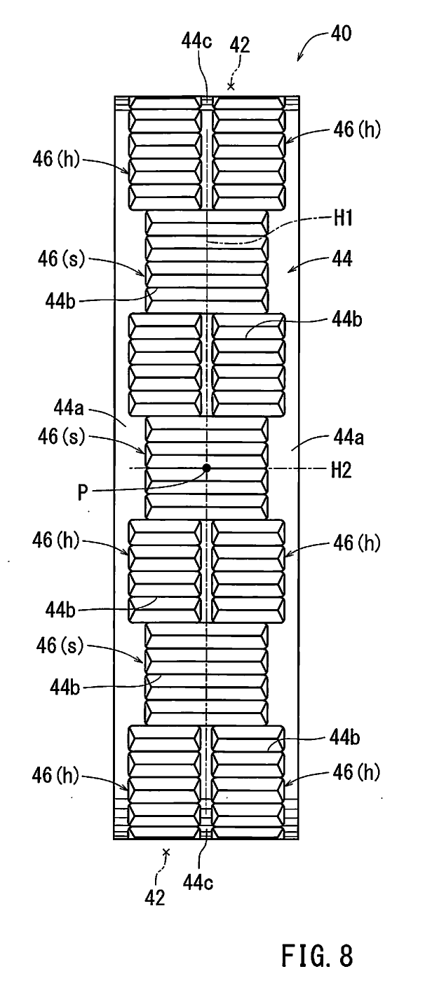

A tolerance ring 40 shown in FIG. 8 includes a cylindrical ring-shaped portion 44 having a mating part 42, and protrusions 46. The ring-shaped portion 44 has side edge portions 44a, seat portions 44b, and a partition portion 44c. The protrusions 46 include seventh protrusions 46(s) as selected protrusions, and eighth protrusions 46(h) as unselected protrusions. A plurality of (e.g., four) seventh protrusions 46(s) are continuously arranged side by side in the peripheral direction to form selected protrusion groups. A plurality of (e.g., four) eighth protrusions 46(h) are continuously arranged side by side in the peripheral direction to form unselected protrusion groups. A row of the selected protrusion groups and two rows of the unselected protrusion groups are continuously arranged alternately side by side in the peripheral direction.

As shown in FIG. 8, the center point in the length direction of each seventh protrusion 46(s) is situated on the center line H1 of the axial width of the ring-shaped portion 44. The total length C of the seventh protrusions 46(s) is larger than the total length C of the eighth protrusions 46(h), and smaller than double the total length C of the eighth protrusions 46(h). The ridge length A of the seventh protrusions 46(s) is a length corresponding to the total length C thereof. The seventh protrusions 46(s) are formed in line symmetry with respect to the center line H1. The eighth protrusions 46(h) are arranged in line symmetry with respect to the center line H1. The seventh protrusions 46(s) and the eighth protrusions 46(h) are arranged in line symmetry with respect to the center line H2 in the peripheral direction.

As shown in FIG. 8, the protrusions 46 are arranged in point symmetry with respect to the center point P of the ring-shaped portion 44. The end portion shape of both end portions of each seventh protrusion 46(s) is the same as the end portion shape of both end portions of each eighth protrusion 46(h). In each of the regions in the vicinity of the mating part 42, four and a half eighth protrusions 46(h) are arranged in each of the right and left rows. The four and a half protrusions in the vicinity of the mating part 42 have the same end portion shape. The total length C of the seventh protrusions 46(s) may be smaller than or larger than double the total length C of the eighth protrusions 46(h).

The seventh protrusions 46(s) and the eighth protrusions 46(h) of FIG. 8 differ from each other in the axial position of the center point in the length direction, total length C, and ridge length A. Thus, the high-pressure portions of the seat portions 44b with respect to the inner shaft member 12 are dispersed in the axial direction, and are not aligned in the peripheral direction. The number of selected protrusions and the number of unselected protrusions are not restricted to those of the embodiment of FIG. 8.

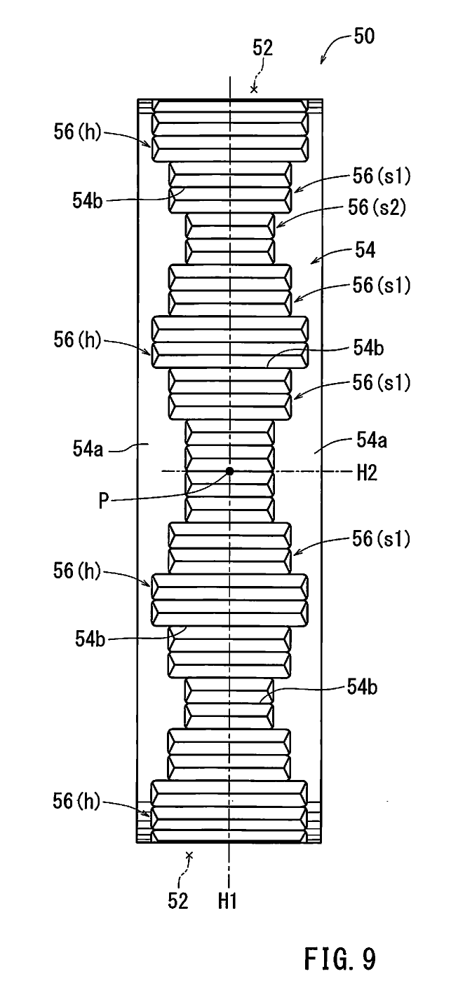

A tolerance ring 50 shown in FIG. 9 includes a cylindrical ring-shaped portion 54 having a mating part 52, and protrusions 56. The ring-shaped portion 54 has side edge portions 54a and seat portions 54b. The protrusions 56 include ninth protrusions 56(s1) and tenth protrusions 56(s2) as selected protrusions, and eleventh protrusions 56(h) as unselected protrusions. A plurality of (e.g., two) ninth protrusions 56(s1) are continuously arranged side by side in the peripheral direction to form first selected protrusion groups. A plurality of (e.g., two) tenth protrusions 56(s2) are continuously arranged side by side in the peripheral direction to form second selected protrusion groups. A plurality of (e.g., two) eleventh protrusions 56(h) are continuously arranged side by side in the peripheral direction to form unselected protrusion groups.

As shown in FIG. 9, the first selected protrusion groups, the second protrusion groups, and the unselected protrusion groups are arranged in a row. The respective center points in the length direction of the first selected protrusion groups, the second protrusion groups, and the unselected protrusion groups are situated on the center line H1 in the axial direction. The protrusions 56 are formed in line symmetry with respect to the center line H1 in the axial direction. The protrusions 56 are arranged in line symmetry with respect to the center line H2 in the peripheral direction. The protrusions 56 are arranged and formed in point symmetry with respect to the center point P of the ring-shaped portion 54. The ninth protrusions 56(s1) and the tenth protrusions 56(s2) have the same end portion shape as that of the eleventh protrusions 56(h).

As shown in FIG. 9, the eleventh protrusions 56(h) exhibit a large total length C, and extend astride the center line H1. The ridge length A of the eleventh protrusions 56(h) is a length corresponding to the total length C thereof. The total length C and the ridge length A of the ninth protrusions 56(s1) are smaller than the total length C and the ridge length A of the eleventh protrusions 56(h). The total length C and the ridge length A of the tenth protrusions 56(s2) are smaller than the total length C and the ridge length A of the ninth protrusions 56(s1).

As shown in FIG. 9, the first selected protrusion groups are adjacent to the second selected protrusion groups. The second selected protrusion groups are arranged between the first selected protrusion groups. The tolerance ring 50 has substantially a columnar shape, and has the center line H2 situated on the side opposite the mating part 52. In the vicinity of the center line H2, two second selected protrusion groups are adjacent to each other. In other words, four tenth protrusions 56(s2) are adjacent to each other. The number of first selected protrusion groups, the number of second selected protrusion groups, and the number of unselected protrusion groups are not restricted to those of the embodiment of FIG. 9.

In FIG. 9, the ninth protrusions 56(s1) and the eleventh protrusions 56(h), or, the tenth protrusions 56(s2) and the eleventh protrusions 56(h), have the same axial position of the center point in the length direction and differ from each other in total length C and ridge length A. Thus, the high-pressure portions of the seat portions 54b with respect to the inner shaft member 12 are dispersed in the axial direction, and are not aligned in the peripheral direction.

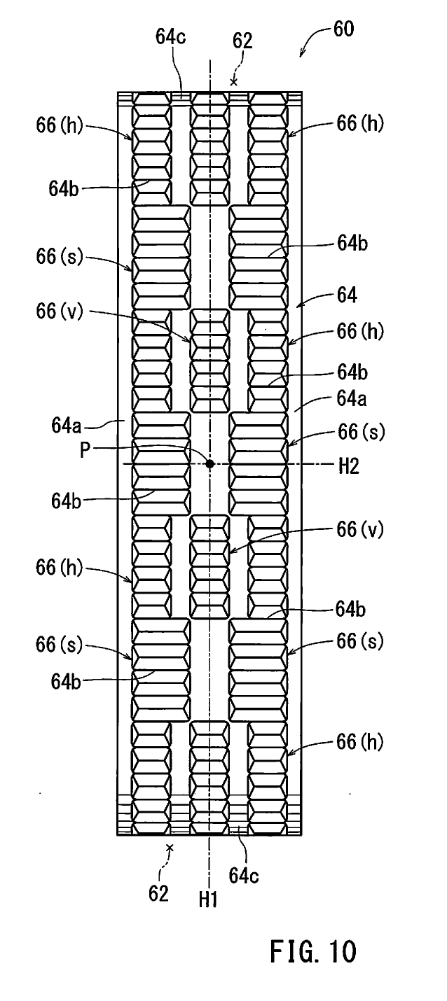

A tolerance ring 60 shown in FIG. 10 includes a cylindrical ring-shaped portion 64 having a mating part 62, and protrusions 66. The ring-shaped portion 64 has side edge portions 64a, seat portions 64b, and partition portions 64c. The protrusions 66 include twelfth protrusions 66(s) as selected protrusions, and thirteenth protrusions 66(h) and fourteenth protrusions 66(v) as unselected protrusions. A plurality of (e.g., four) twelfth protrusions 66(s) are continuously arranged side by side in the peripheral direction to form selected protrusion groups. A plurality of (e.g., four) thirteenth protrusions 66(h) are continuously arranged side by side in the peripheral direction to form unselected protrusion groups. A plurality of (e.g., four) fourteenth protrusions 66(v) are continuously arranged side by side in the peripheral direction to form unselected protrusion groups.

As shown in FIG. 10, the tolerance ring 60 has three rows of unselected protrusion groups and two rows of selected protrusion groups. The protrusions 66 are arranged in line symmetry with respect to the center line H1 in the axial direction. The protrusions 66 are arranged in line symmetry with respect to the center line H2 in the peripheral direction. The protrusions 66 are arranged and formed in point symmetry with respect to the center point P of the ring-shaped portion 64. The twelfth protrusions 66(s) have both end portions that have the same shape as both end portions of the thirteenth protrusions 66(h) and of the fourteenth protrusions 66(v).

As shown in FIG. 10, the thirteenth protrusions 66(h) are situated in both side regions in the axial direction of the ring-shaped portion 64. The outer end portions of the thirteenth protrusions 66(h) are situated at the same axial position as the outer end portions of the twelfth protrusions 66(s), and are aligned in the peripheral direction. The fourteenth protrusions 66(v) are situated at the center in the axial direction of the ring-shaped portion 64. Both end portions of the fourteenth protrusions 66(v) are situated so as to be axially in correspondence with the inner end portions of the twelfth protrusions 66(s), and are aligned in the peripheral direction. Alternatively, both end portions of the fourteenth protrusions 66(v) are slightly deviated in the axial direction from the inner end portions of the twelfth protrusions 66(s).

As shown in FIG. 10, the total length C and the ridge length A of the twelfth protrusions 66(s) are larger than the total length C and the ridge length A of the thirteenth protrusions 66(h) and of the fourteenth protrusions 66(v). For example, four and a half thirteenth protrusions 66(h) and four and a half fourteenth protrusions 66(v) are arranged in the region in the vicinity of the mating part 62.

In FIG. 10, the twelfth protrusions 66(s) and the thirteenth protrusions 66(h), or, the twelfth protrusions 66(s) and the fourteenth protrusions 66(v), differ from each other in the axial position of the center position in the length direction, total length C, and ridge length A. Thus, the high-pressure portions of the seat portions 64b with respect to the inner shaft member 12 are dispersed in the axial direction, and are not aligned in the peripheral direction.

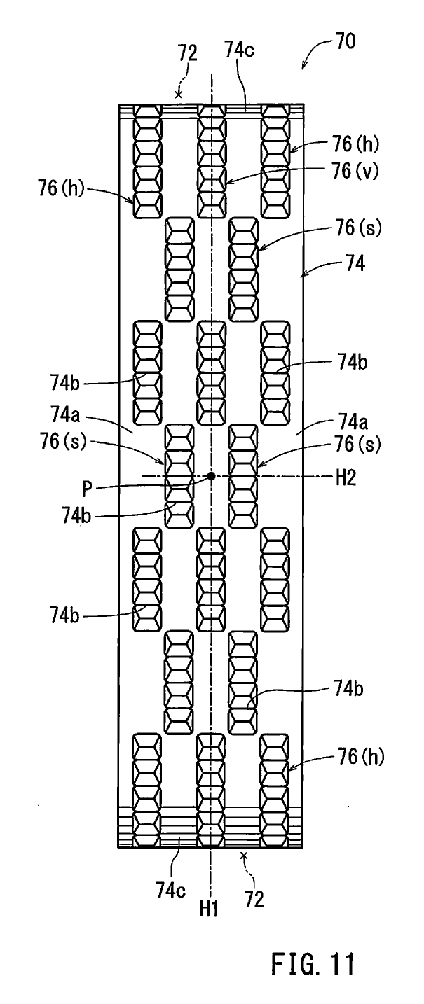

A tolerance ring 70 shown in FIG. 11 includes a cylindrical ring-shaped portion 74 having a mating part 72, and protrusions 76. The ring-shaped portion 74 has side edge portions 74a, seat portions 74b, and partition portions 74c. The protrusions 76 include fifteenth protrusions 76(s) as selected protrusions, and sixteenth protrusions 76(h) and seventeenth protrusions 76(v) as unselected protrusions. A plurality of (e.g., four) fifteenth protrusions 76(s) are continuously arranged side by side in the peripheral direction to form selected protrusion groups. A plurality of (e.g., four) sixteenth protrusions 76(h) are continuously arranged side by side in the peripheral direction to form unselected protrusion groups. A plurality of (e.g., four) seventeenth protrusions 76(v) are continuously arranged side by side in the peripheral direction to form unselected protrusion groups.

As shown in FIG. 11, the tolerance ring 70 has three rows of unselected protrusion groups, and two rows of selected protrusion groups. The protrusions 76 have the same shape. The protrusions 76 are arranged in line symmetry with respect to the center line H1 in the axial direction. The protrusions 76 are arranged in line symmetry with respect to the center line H2 in the peripheral direction. The protrusions 76 are arranged and formed in point symmetry with respect to the center point P of the ring-shaped portion 74.

As shown in FIG. 11, the sixteenth protrusions 76(h) are situated in both side regions in the axial direction of the ring-shaped portion 74. The inner end portions of the sixteenth protrusions 76(h) are situated at the same axial position as the outer end portions of the fifteenth protrusions 76(s), and are aligned in the peripheral direction. Alternatively, the inner end portions of the sixteenth protrusions 76(h) are slightly deviated in the axial direction from the outer end portions of the fifteenth protrusions 76(s). Both end portions of the seventeenth protrusions 76(v) are slightly deviated in the axial direction with respect to the inner end portions of the fifteenth protrusions 76(s), and are not aligned in the peripheral direction. For example, four and a half sixteenth protrusions 76(h) or four and a half seventeenth protrusions 76(v) are arranged in the region in the vicinity of the mating part 72.

In FIG. 11, the fifteenth protrusions 76(s) and the sixteenth protrusions 76(h), or, the fifteenth protrusions 76(s) and the seventeenth protrusions 76(v), have the same shape, and differ from each other in the axial position of the center position in the length direction. Thus, the high-pressure portions of the seat portions 74b with respect to the inner shaft member 12 are dispersed in the axial direction, and are not aligned in the peripheral direction.

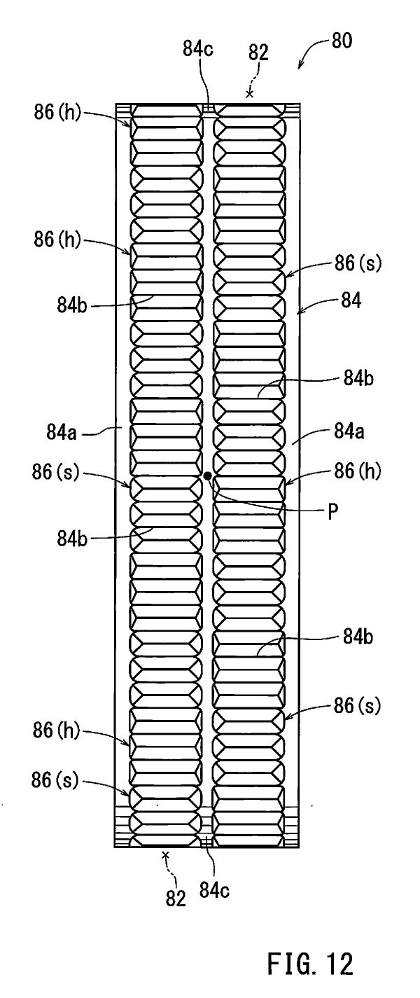

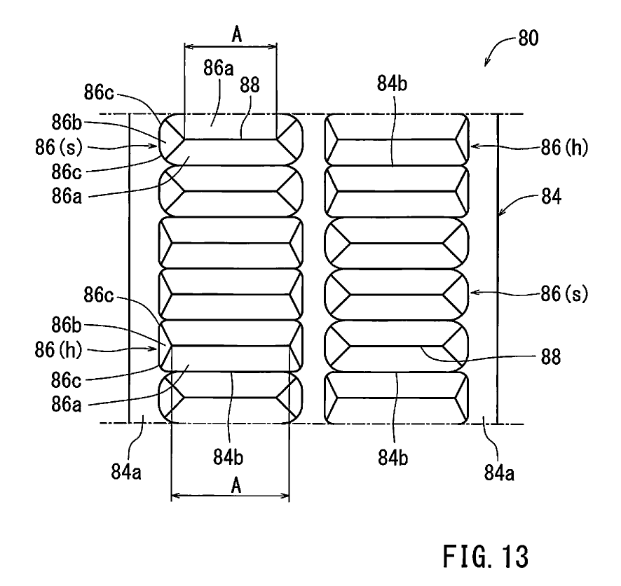

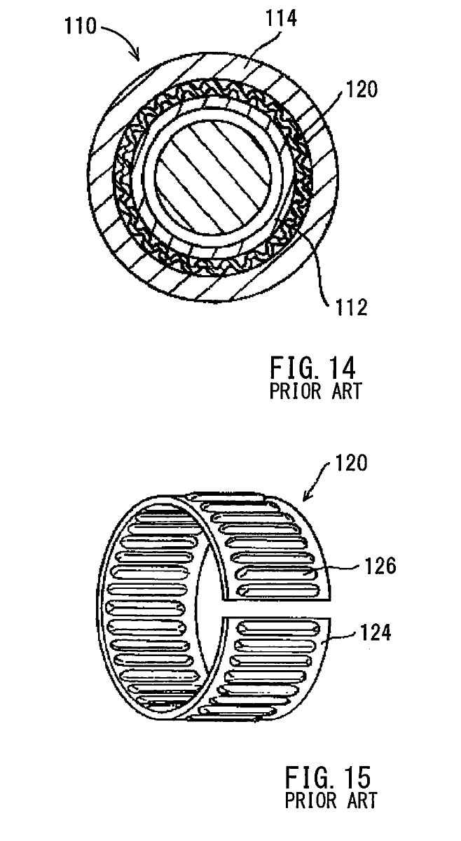

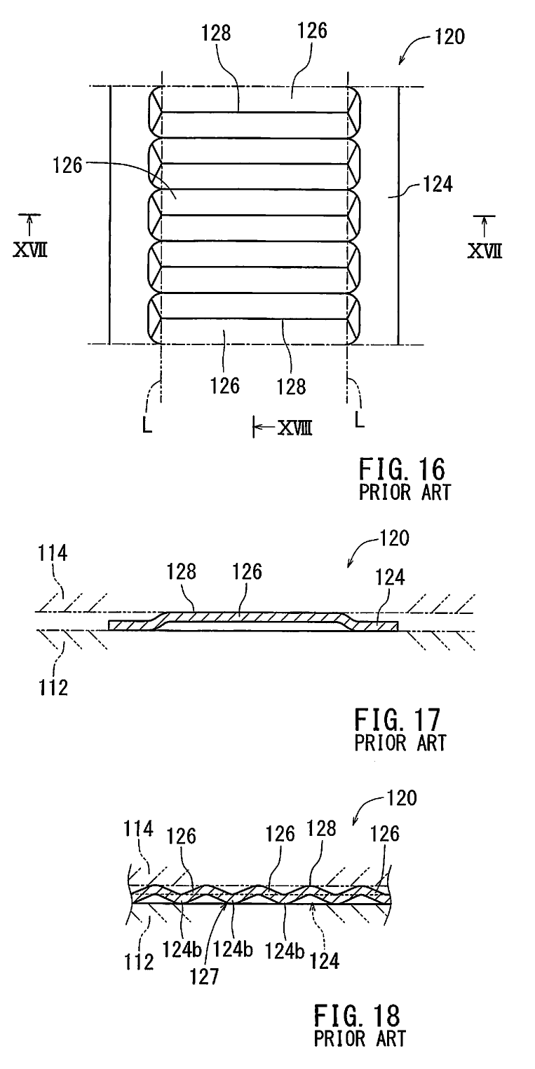

A tolerance ring 80 shown in FIGS. 12 and 13 includes a cylindrical ring-shaped portion 84 having a mating part 82, and protrusions 86. The ring-shaped portion 84 has side edge portions 84a, seat portions 84b, and a partition portion 84c. The protrusions 86 include eighteenth protrusions 86(s) as selected protrusions, and nineteenth protrusions 86(h) as unselected protrusions. A plurality of (e.g., three) eighteenth protrusions 86(s) are arranged continuously side by side in the peripheral direction to form selected protrusion groups. A plurality of (e.g., three) nineteenth protrusions 86(h) are arranged continuously side by side in the peripheral direction to form unselected protrusion groups.

As shown in FIGS. 12 and 13, the tolerance ring 80 has two rows of protrusions 86, and selected protrusion groups and unselected protrusion groups are alternately arranged in each row. The eighteenth protrusions 86(s) have a total length C and a total width D that are the same as those of the nineteenth protrusions 86(h). The protrusions 86 are arranged in point symmetry with respect to the center point P of the ring-shaped portion 84. The eighteenth protrusions 86(s) and the nineteenth protrusions 86(h) of each row have the same axial position of the center point in the length direction, and are arranged in a row in the peripheral direction. The outer end portions of the eighteenth protrusions 86(s) and the nineteenth protrusions 86(h) of each row have the same axial position, and are aligned in the peripheral direction. The inner end portions of the eighteenth protrusions 86(s) and the nineteenth protrusions 86(h) of each row have the same axial position, and are aligned in the peripheral direction.

As shown in FIGS. 12 and 13, the eighteenth protrusions 86(s) have corners of a larger radius of curvature than the corners of the nineteenth protrusions 86(h). As a result, the eighteenth protrusions 86(s) and the nineteenth protrusions 86(h) differ from each other in end portion shapes. The eighteenth protrusions 86(s) and the nineteenth protrusions 86(h) differ from each other in ridge length A. That is, the eighteenth protrusions 86(s) have a ridge length A smaller than the ridge length A of the nineteenth protrusions 86(h). For example, two and a half eighteenth protrusions 86(s) are arranged in one region (left lower region) in the vicinity of the mating part 82 of the left row. For example, two and a half nineteenth protrusions 86(h) are arranged in the other region (left upper region in FIG. 12) in the vicinity of the mating part 82 of the left row.

The eighteenth protrusions 86(s) and the nineteenth protrusions 86(h) of FIGS. 12 and 13 have the same total length C and differ from each other in ridge length A and end portion shape. Thus, the high-pressure portions of the seat portions 84b with respect to the inner shaft member 12 are dispersed in the axial direction, and are not aligned in the peripheral direction.

While the embodiments of invention have been described with reference to specific configurations, it will be apparent to those skilled in the art that many alternatives, modifications and variations may be made without departing from the scope of the present invention. Accordingly, embodiments of the present invention are intended to embrace all such alternatives, modifications and variations that may fall within the spirit and scope of the appended claims. Embodiments of the present invention should not be limited to the representative configurations, but may be modified, for example, as described below.

The above-described tolerance ring can be used in the torque transmission device 10. Alternatively, the tolerance ring may be used for the purpose of preventing rattling. For example, it may be provided between the two shaft members 12 and 14 so as to prevent rattling between the two shaft members 12 and 14 in the hinge device of a door or the like. The tolerance ring may be formed of metal or resin.

As described above, the protrusions protrude radially outwards from the ring-shaped portion. Alternatively, the protrusions may protrude radially inwards from the ring-shaped portion. In this case, the protrusions bring the ring-shaped portion into close contact with the inner peripheral surface of the outer shaft member due to the elastic restoring force. The ridges of the protrusions are brought into close contact with or engaged in the outer peripheral surface of the inner shaft member by utilizing the elastic force.

In the present specification, the expression “something is the same” may include cases where it is substantially the same. As described above, the tolerance ring is formed in line symmetry or point symmetry. Alternatively, the tolerance ring may be asymmetrical with respect to a line or asymmetrical with respect to a center.

In the tolerance rings shown in FIGS. 3 and 7 to 12, a plurality of (e.g., thirty or four) protrusions are continuously adjacent to each other in the peripheral direction. Alternatively, two or more protrusions may be continuously adjacent to each other in the peripheral direction. Because the plurality of protrusions are continuously adjacent to each other in the peripheral direction, the number of protrusions is increased in the peripheral direction. As a result, the load capacity due to the protrusions is increased. Further, when the protrusions undergo elastic deformation, the adjacent protrusions can interfere with each other. This may cause the load capacity due to the protrusions to be increased.

In the tolerance ring 20 of FIG. 3, all the selected protrusions (26(s)) are continuously adjacent to the unselected protrusions (26(h) or 26(v)) in the peripheral direction. In the tolerance rings of FIGS. 7 to 10 and 12, all the selected protrusion groups are adjacent to the unselected protrusion groups in the peripheral direction. Alternatively, at least one selected protrusion group may be adjacent to the unselected protrusion groups in the peripheral direction, and the other selected protrusion groups may not be adjacent to the unselected protrusion groups.

In the tolerance rings of FIGS. 3, 7 to 10, and 12, a plurality of protrusions are continuously adjacent to each other over the entire length in the peripheral direction of the ring-shaped portion. Alternatively, a plurality of protrusions may be continuous in at least in one region in the peripheral direction of the ring-shaped portion, and may not be continuous in the other regions.

In the tolerance rings of FIGS. 7 and 8, the selected protrusions situated in one region with respect to the center line of the axial width of the ring-shaped portion (the fifth protrusions 36(s) and the seventh protrusions 46(s)) extend beyond the center line. On the other hand, the unselected protrusions (the sixth protrusions 36(h) and the eighth protrusions 46(h)) do not extend beyond the center line. In the tolerance rings of FIGS. 10 and 11, the fourteenth protrusions 66(v) and the seventeenth protrusions 76(v) constituting the unselected protrusions extend beyond the center line of the axial width of the ring-shaped portion. On the other hand, the selected protrusions (the twelfth protrusions 66(s) and the fifteenth protrusions 76(s)) do not extend beyond the center line. In FIG. 3, the tolerance ring may have the first protrusions 26(s) or the second protrusions 26(h) instead of the third protrusions 26(t) and the fourth protrusions 26(v). In this case, the selected protrusions (26(s)) situated in one region with respect to the center line of the axial width of the ring-shaped portion extend beyond the center line. On the other hand, the unselected protrusions (26(h)) do not extend beyond the center line.

The tolerance rings of FIGS. 10 and 11 have paired unselected protrusions (66(h)), 76(h)) and center unselected protrusions (66(v), 76(v)). The paired unselected protrusions (66(h)), 76(h)) are arranged in line symmetry with respect to the center line of the axial width of the ring-shaped portion. The center unselected protrusions (66(v), 76(v)) are arranged between the paired unselected protrusions (66(h)), 76(h)). The paired unselected protrusions and the center unselected protrusions may have the same shape or may have different shapes. Due to the center unselected protrusions, three or more unselected protrusions are arranged in the same axis. As a result, it is possible to disperse the high-pressure portions of the seat portions in the axial direction.

In the tolerance ring of FIG. 10, the axial outer end portions of the paired unselected protrusions (66(h)) and the axial outer end portions of the selected protrusions (66(s)) are situated at the same axial position, and are arranged side by side in the peripheral direction. Alternatively, the axial outer end portions of the paired unselected protrusions (66(h)) and the axial outer end portions of the selected protrusions (66(s)) may be situated at different axial positions.

The tolerance ring of FIG. 10 has paired selected protrusions (66(s)) arranged in line symmetry with respect to the center line of the axial width of the ring-shaped portion. The axial end portions of the center unselected protrusions (66(v)) and the axial inner end portions of the paired selected protrusions (66(s)) are situated at the same axial position, and are arranged side by side in the peripheral direction. Alternatively, the axial end portions of the center unselected protrusions (66(v)) and the axial inner end portions of the paired selected protrusions (66(s)) may be of different axial positions.

The selected protrusions (86(s)) and the unselected protrusions (86(h)) of FIGS. 12 and 13 are the same in total length, the axial position of the center point in the length direction, and total width in the peripheral direction, and differ from each other in end portion shape and ridge length. In addition, the selected protrusions (86(s)) and the unselected protrusions (86(h)) may have different total widths in the peripheral direction.

1. A tolerance ring for a torque transmission device wherein the tolerance ring is arranged in an annular space between an inner shaft member and an outer shaft member which are concentric with each other and which overlap each other in a radial direction, and wherein the tolerance ring transmits torque between the two shaft members when the torque between the two shaft members is smaller than a predetermined value, and the tolerance ring slips on at least one of the two shaft members to interrupt the torque transmission between the two shaft members when the torque between the two shaft members is not smaller than the predetermined value, the tolerance ring comprising:
a ring-shaped portion having a cylindrical shape, the ring-shaped portion configured to be brought into contact with one of the two shaft members; and
a plurality of protrusions which undergo elastic deformation between the two shaft members and which are arranged in a peripheral direction, wherein
the ring-shaped portion has seat portions formed between the plurality of protrusions that are adjacent to each other in the peripheral direction,
the plurality of protrusions include selected protrusions that have the same shape and that are situated at the same axial position and unselected protrusions other than the selected protrusions, and the selected protrusions and the unselected protrusions differ from each other at least in one of total length, ridge length, end portion shape, and axial position of center point in a length direction.

2. The tolerance ring for a torque transmission device of claim 1 wherein at least two of the plurality of protrusions are continuously adjacent with each other in the peripheral direction.

3. The tolerance ring for a torque transmission device of claim 1 wherein at least one of the selected protrusions and at least one of the unselected protrusions are continuously adjacent with each other in the peripheral direction.

4. The tolerance ring for a torque transmission device of claim 1 wherein the plurality of protrusions are continuously adjacent with each other over an entire peripheral length of the ring-shaped portion.

5. The tolerance ring for a torque transmission device of claim 1 wherein
either the selected protrusions or the unselected protrusions, but not both, situated in one region with respect to a center line of an axial width of the ring-shaped portion extend beyond the center line,
either the selected protrusions or the unselected protrusions, but not both, situated in other region with respect to the center line extend beyond the center line.

6. The tolerance ring for a torque transmission device of claim 1 wherein the unselected protrusions include paired unselected protrusions arranged in line symmetry with respect to a center line of an axial width of the ring-shaped portion and center unselected protrusions arranged between the paired unselected protrusions.

7. The tolerance ring for a torque transmission device of claim 6 wherein axial outer end portions of the paired unselected protrusions and axial outer end portions of the selected protrusions are situated at the same axial position, and are arranged side by side in the peripheral direction.

8. The tolerance ring for a torque transmission device of claim 6 wherein the selected protrusions include paired selected protrusions arranged in line symmetry with respect to the center line of the axial width of the ring-shaped portion.

9. The tolerance ring for a torque transmission device of claim 8 wherein both axial end portions of the center unselected protrusions and axial inner end portions of the paired selected protrusions are situated at the same axial position, and are arranged side by side in the peripheral direction.

10. The tolerance ring for a torque transmission device of claim 1 wherein the selected protrusions and the unselected protrusions have the same total length and the same axial position of center point in a length direction, and differ from each other in end portion shape and ridge length.

11. The tolerance ring for a torque transmission device of claim 1 wherein the selected protrusions and the unselected protrusions have the same axial position of center point in a length direction, and differ form each other in total length and ridge length.

12. The tolerance ring for a torque transmission device of claim 1 wherein the selected protrusions and the unselected protrusions have the same shape, and differ from each other in axial position of center point in a length direction.

13. The tolerance ring for a torque transmission device of claim 1 wherein the selected protrusions and the unselected protrusions have the same total length, and differ from each other in ridge length and end portion shape.
